(19) United States
(12) Patent Application Publication
(10) Pub. No.: US 2026/0306892 A1
(43) Pub. Date: Oct. 8, 2026

(54) FIRE EXTINGUISHER

(71) Applicant: MAUS SWEDEN AB, Lidköping (SE)

(72) Inventor: Andreas C. NORLIN, MARBELLA (ES)

(73) Assignee: MAUS SWEDEN AB, Lidköping (SE)

(21) Appl. No.: 19/482,284

(22) PCT Filed: Apr. 22, 2024
(86) PCT No.: PCT/SE2024/050388

§ 371 Date: Nov. 7, 2025

(30) Foreign Application Priority Data
May 9, 2023 (SE) 2350572-0

(51) Int. Cl. A62C 37/48; A62C 35/08

(52) U.S. Cl. CPC A62C 37/48; A62C 35/08

(57) ABSTRACT

The present invention relates to a fire extinguisher (100) comprising a container (110, 110a, 110b), a fire extinguishing substance (170b) located in said container (110, 110a, 110b), a force producing means (170a) located in said container (110, 110a, 110b). Said container (110, 110a, 110b) comprises at least a first and a second contact port (120, 120a, 120b) for removably attaching a first and/or a second heat sensitive means (150, 152, 154) for actuating said force producing means (170a) in the presence of heat above an undesired level to allow said fire extinguishing substance (170b) to pass out of said container (110, 110a, 110b).

### TECHNICAL FIELD

The present invention relates generally to means for extinguishing fires and in particular to self-triggering fire extinguisher.

### BACKGROUND ART

Fire extinguishers and fire extinguishing systems are available on the market in numerous forms. Portable fire extinguishers have been designed for extinguishing fires primarily before the fire has a chance to develop into a large conflagration. The primary problem with portable fire extinguishers is that they are not automatic and must be operated by hand in some fashion or another. The manual operation of the portable fire extinguishers may cause a delay in extinguishing the fire for availability reason and/or because of unfamiliarity with the operation of the device and/or misdirection of the extinguishing agent.

In order to overcome the problems of the portable fire extinguishers mentioned above, automatic fire extinguishers have been developed. The idea with such fire extinguishers is that they automatically shall extinguish fires without influence of a human being. One problem with automatic fire extinguisher is that they may be expensive to purchase and/or install. Another problem is that automatic fire extinguisher has low installation flexibility, the system may often be predesigned without any possibility of modification of the particular place one wants to protect.

### SUMMARY OF INVENTION

It is an object of the present invention to provide a flexible, effective and/or practical automatic fire extinguisher suitable to be installed in a variety of different places.

In a first aspect of the present invention it is provided a fire extinguisher comprising: a container, a fire extinguishing substance located in said container and a force producing means located in said container. Said container comprises at least a first and a second contact port for removably attaching a first and/or a second heat sensitive means for actuating said force producing means in the presence of heat above an undesired level to allow said fire extinguishing substance to pass out of said container, wherein said heat sensitive means is a heat sensitive wire and wherein said heat sensitive wire is a metallic wire having a high thermal conductivity, a fast burning substance located around said wire, cover means wrapped around said fast burning substance to provide strength for said heat sensitive means and to hold said fast burning substance in place.

The advantage of the present invention is that heat sensitive means may be removably attached to said container resulting an enhanced installation flexibility of the fire extinguisher. Another advantage is that a predetermined length of the heat sensitive means, i.e., the fuse or firetrain for triggering the fire extinguisher, may be chosen for a predetermined situation. Another advantage is that one or several containers may be attached to each other via said removable heat sensitive means. Still another advantage with the present invention is that the fire extinguisher is maintenance free independent of atmosphere pressure and does not require battery or electric power connection. Yet another advantage is that the fire extinguisher is independent and does not require an adapted infrastructure to function.

In various example embodiments of the present invention said fire extinguishing substance and said force producing means is a single unit.

The advantage of these embodiments is that the number of individual components is reduces. Another advantage is that the assembly of the fire extinguisher is simplified.

In various example embodiments of the present invention said single unit of said fire extinguishing substance and said force producing means is in solid form.

The advantage of these embodiments is that assembly of the fire extinguisher may be simplified. Another advantage is that the container may be provided with perforations for allowing escape of said fire extinguishing substance without risking said fire extinguishing substance and/or said force producing means for falling out of said container prior to use.

In various example embodiments of the present invention said container comprises fastening means for attaching said container to an item.

The advantage of these embodiments is that said fire extinguisher may be attached to various types of surfaces.

In another aspect of the present invention, it is provided a fire extinguisher unit comprising: a first container, a second container, a fire extinguishing substance located in said first container and in said second container, a force producing means located in said first container and in said second container. Said first container comprises at least a first and a second contact port for removably attaching a first and/or a second heat sensitive means for actuating said force producing means in the presence of heat above an undesired level to allow said fire extinguishing substance to pass out of said first container, said second container comprises at least a first and a second contact port for removably attaching a first and/or a second heat sensitive means for actuating said force producing means in the presence of heat above an undesired level to allow said fire extinguishing substance to pass out of said second container, wherein said first and second container are configured to connected to each other via at least one heat sensitive means, wherein said heat sensitive means is a heat sensitive wire and wherein said heat sensitive wire is a metallic wire having a high thermal conductivity, a fast burning substance located around said wire, cover means wrapped around said fast burning substance to provide strength for said heat sensitive means and to hold said fast burning substance in place.

The advantage of this embodiment is that the fire extinguisher may cover a large space with easy installation.

In yet another aspect of the present invention it is provided a kit comprising at least one fire extinguisher and at least one heat sensitive means wherein said at least one fire extinguisher comprising: a container, a fire extinguishing substance located in said container, a force producing means located in said container. Said container comprises at least a first and a second contact port for removably attaching said at least one heat sensitive means for actuating said force producing means in the presence of heat above an undesired level to allow said fire extinguishing substance to pass out of said container.

The advantage of this embodiment is that the fire extinguisher may be sold in various forms suitable for different applications. The kit may be one container with a predetermined length of heat sensitive means. The kit may comprise a plurality of containers attachable to each other together with a predetermined length of heat sensitive means. The length and number of heat sensitive means may be chosen by the customer when purchasing the kit online.

### BRIEF DESCRIPTION OF DRAWINGS

The invention is now described, by way of example, with reference to the accompanying drawings, in which:

FIG. 1 depicts a perspective view of a first example embodiment of fire extinguisher according to the present invention.

FIG. 2 depicts a perspective view of the fire extinguisher with removably attached first and/or a second heat sensitive means.

FIG. 3 depicts a perspective exploded view of the fire extinguisher as depicted in FIG. 1.

FIG. 4 depicts a perspective view of a second example embodiment of fire extinguisher according to the present invention.

FIG. 5. depicts a perspective exploded view of another example embodiment of a fire extinguisher according to the present invention.

### DESCRIPTION OF EMBODIMENTS

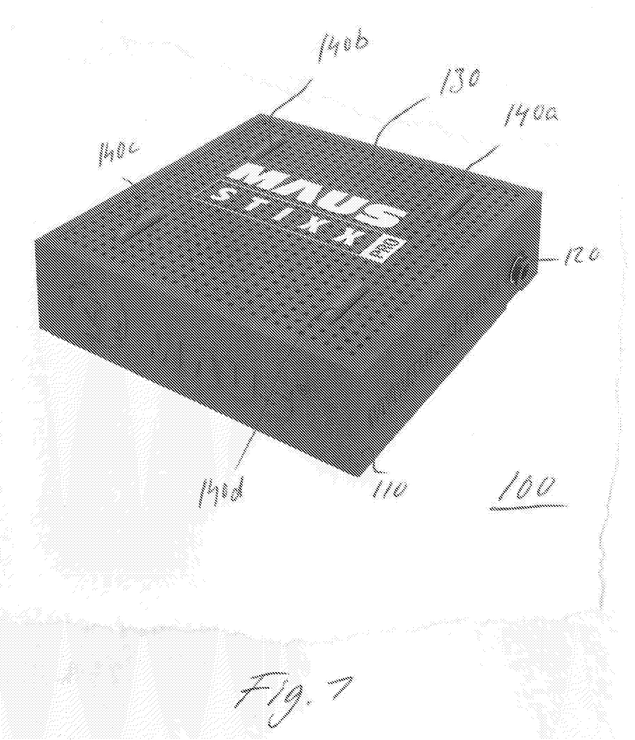

Referring now to FIG. 1-4, the fire extinguisher illustrated therein is identified by reference numeral 100 and comprises a container 110, 110a, 110b. The container 110, 110a, 110b may have any shape and is here illustrated to have a rectangular box-shaped design. A top surface 130 of said container may be perforated for allowing a fire extinguishing substance 170b to pass out of said container. The container 110, 110a, 110b further comprises at least a first and a second contact port 120, 120a, 120b for removably attaching a first and/or a second heat sensitive means 150, 152, 154 for actuating a force producing means 170a provided inside said container 110, 110a, 110b in the presence of heat above an undesired level to allow said fire extinguishing substance 170b to pass out of said container 110. The force producing means 170a and said fire extinguishing substance 170b may be mixed together for forming a solid substance 170a, b inside said container 110, 110a, 110b. When said force producing means 170a is ignited by said heat sensitive means, said force producing means 170a will explode and disintegrate the fire extinguishing substance 170b into fine particles. Sid fine particles may escape through said perforations in the container. Alternatively, said container 110 may be provided with rupturable segments in the form of grooves or scored lines, which may be ruptured when said forcing means 170a is exploded, thereby forming an opening in said container 110 for allowing said fire extinguishing substance 170b to pass out of the container 110.

The fire extinguishing substance 170b may comprise monoammonium phosphate. Alternatively said fire extinguishing substance 170b may comprise sodium bicarbonate. The fine particles (aerosols) in the fire extinguishing substance absorbs heat from the fire, so called heterogenous catalytic reaction. The aerosol may be in the form of a potassium compound. Potassium radicals may stop the chemical reactions taking place in a fire by neutralizing hydrogen, oxygen and hydroxy radicals in the flame. The fine fire extinguishing particles is a very effective extinguishing means. Small particles will be floating in the ambient air a longer time compared to larger particles. The prolonged floating time may contribute to a increased protection against re-ignition.

The force producing means 170a may for instance be nitrogen sulfide, cadmium azide, sodium fulminate, potassium fulminate, zinc azide or similar. The force producing means 170a and said fire extinguishing substance 170b may be mixed together with or without a binding element for forming said solid substance 170a, b. Said binding element may be shellac, glucose, ester gum or similar.

Said container 110, 110a, 110b comprises said at least a first and a second contact port 120, 120a, 120b for removably attaching said first and/or a second heat sensitive means 150, 152, 154 for actuating said force producing means 170a. In FIG. 1-4 only one contact port is shown as the other contact port is hidden on the opposite side of said container 110, 110a, 110b with respect to said illustrated contact port 120, 120a, 120b. Said first and second contact ports may be arranged anywhere on said container, i.e., on the same surface next to each other, on opposite surfaces or on surfaces next to each other. In various example embodiments said container may comprise more than 2 contact ports, e.g., 3, 4, 5 or more.

The first and second heat sensitive means 150, 152, 154 may function as a fuse or firetrain for igniting the force producing means 170a. The heat sensitive means may be in the form of a thin low resistance metal material, for instance copper, coated with a fast burning highly flammable material. Said fast burning highly flammable material may be on the form of fine silicon powder, zinc powder and lead peroxide. The silicon power may have a powder particle distribution of 2-3 microns. The silicon powder content in said fuse may be in the range of 30-60%. The zinc power content may be in the range from 0.5-10%. The Lead peroxide content in said fuse may be in the range from 30-60%. Different compositions of the above example embodiment of fuse may vary the ignition temperature. In an example embodiment said ignition temperature may be at or around 180° C. The fuse may also be traditional black match. The fuse or firetrain may ignite without any assistance of electrical connections, i.e., said fuse or firetrain may ignite on temperature only making the fire extinguisher totally independent of any electrical connection.

The first and second heat sensitive means 150, 152, 154 may be removably attached to said container, 110, 110a, 110b. The first and second heat sensitive means 150, 152, 154 may be of any length, e.g., from a few cm to several m in length. An advantage of having a long first and/or second heat sensitive means is that a larger volume may be protected from fire.

In FIG. 1-4 it is also illustrated a first and second internal heat sensitive means 141a, 141b. Said internal heat sensitive means 141a, 141b may have the same functionality as the first and second heat sensitive means 150, 152, 154, i.e., a fuse or firetrain for igniting the force producing means 170a. The internal heat sensitive means 141a, 141b may be in the form of a metal wire coated with a similar fast burning highly flammable material as disclosed above. The internal heat sensitive means 141a, 141b may mainly be provided inside said container 110, 110a, 110b. The internal heat sensitive means 141a, 141b may, as depicted in FIG. 1-4, protrude out of said container 110. In FIG. 1-4 said internal heat sensitive means 141a, 141b is protruding out of the top surface 130 provided with said perforations. Protrusions 140a, 140b, 140c, 140d, 140e, 140f, 140g, 140h of said internal heat sensitive means 141a, 141b may protrude from openings 142a, 142b, 142c, 142d in any surface of said container 110. In FIG. 1-4 said internal heat sensitive means 141a, 141b is exemplified to be provided with two protrusions each, however, more or less protrusion per internal heat sensitive means 141a, 141b may be equally applicable. In various example embodiments said internal heat sensitive means 141a, 141b may as depicted in FIG. 1-4 be equal to each other. In various example embodiments a first and a second internal heat sensitive means 141a, 141b provided in a container 110 may be different to each other, e.g., a first internal heat sensitive means may have no protrusions extending outside said container, whereas a second internal heat sensitive means may have one, two or more protrusions. In various example embodiments said first internal heat sensitive mans may have one protrusion and a second internal heat sensitive means may have two or more protrusions. In various example embodiments a first internal heat sensitive means may have at least one protrusion from a first surface of said container 110 whereas a second internal heat sensitive means may have at least one protrusion from a second surface of said container 110. The protrusions 140a, 140b, 140c, 140d, 140e, 140f, 140g, 140h extending out of said container will give the fire extinguisher functionality without attaching any one of the first and/or second heat sensitive means 150, 152, 154.

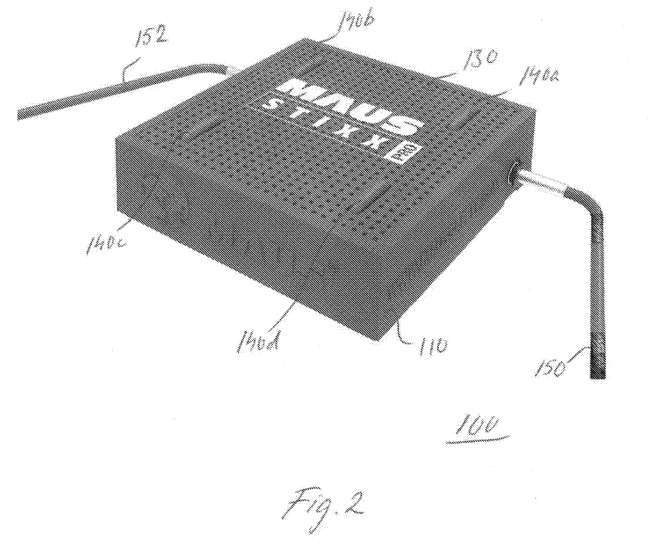

FIG. 1 depicts the fire extinguisher 100 without the first and/or second heat sensitive means 150, 152, 154 attached to the container 110. FIG. 2 depicts the fire extinguisher 100 with said first and second heat sensitive means 150, 152 attached to the container 110.

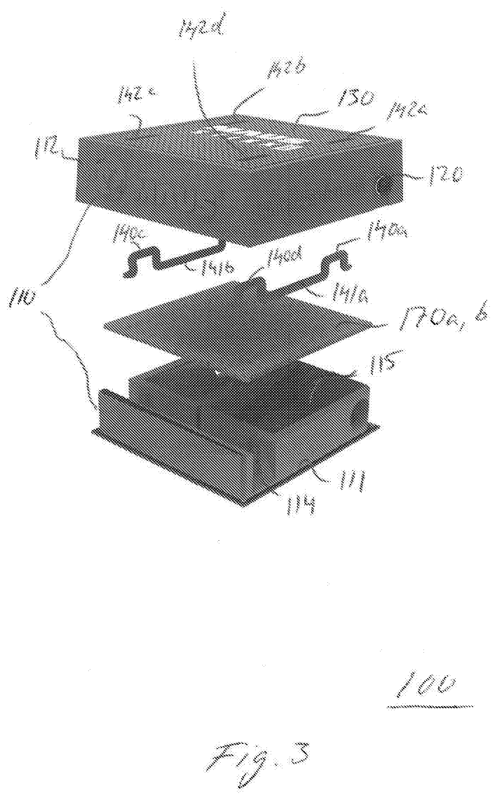

FIG. 3 depicts an exploded perspective view of a fire extinguisher 100 according to the present invention. The container 110 comprises a lid 112 and a bottom portion 111. The lid 112 may as depicted comprise said top surface 130 with said perforations and said openings 142a, 142b, 142c, 142d. Said lid 112 may also comprise one or a plurality of said contact ports 120. Inside said container 110 said first and second internal heat sensitive means 141a, 141b respectively may be provided. In an assembled fire extinguisher, at least a portion of said first and second internal heat sensitive means 141a, 141b is contacting said solid substance 170a, b comprising said force producing means 170a, and said fire extinguishing substance 170b. In assembled form at least a portion of said first and second contact port 120 is also contacting said solid substance 170a, b directly and/or indirectly via said internal heat sensitive means 141a, 141b. The solid substance may comprise: potassium nitrate with a concentration about 50-75%, strontium nitrate with a concentration about 20-35%, melamine with a concentration about 10-20%, phenolic resin with a concentration about 5-15% and sodium hydrogen tartrate monohydrate with a concentration about 5-15%. The solid substance 170a, b may be in the form of a thin plate. The solid substance 170a, b may be provided in a box like compartment 115 in said bottom portion 111. The bottom portion 111 and said lid 112 may be made of plastic material, metal material or a renewable material. The internal heat sensitive means 141a, 141b, 141a, 141d, 141e may as depicted be exposed out of the lid 112 through said openings 142a, 142b, 142c, 142d, i.e. the fire extinguisher may function with internal heat sensitive means 141a, 141b, 141a, 141d, 141e only.

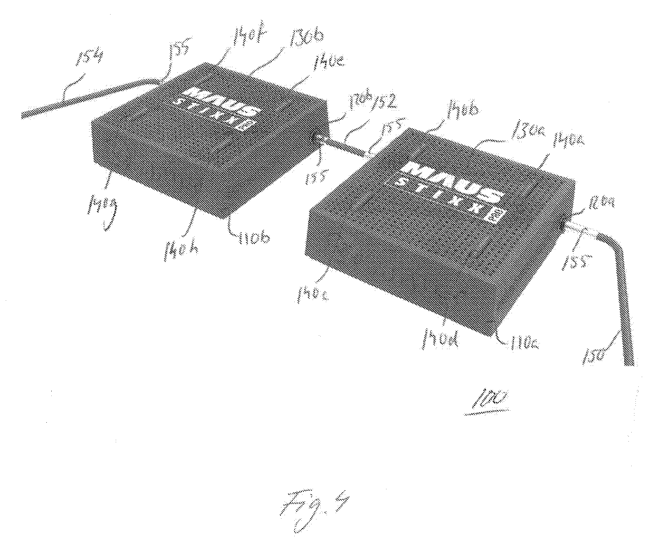

FIG. 4 depicts a fire extinguisher 100 with a first container 110a and a second container 110b connected to each other via a heat sensitive means 152. A second contacting port (not shown) in said first container 110a is contacting a first contacting port 120b in said second container 110b with said heat sensitive means 152. A first contacting port 120a in said first container 110a is provided with a heat sensitive means 150 which may or may not be connected to yet another container. A second contacting port (not shown) in said second container 110b is provided with a heat sensitive means 154 which may or may not be connected to still another container. Sleeve 155 is provided at he and of heast sensitive means 150, 152, 154.

The container 110a, 110b may be provided with attaching means in the form of one or a plurality of magnets provided on one or a plurality of surfaces of said container. Alternatively, said attaching means may be in the form of resilient gripping means configured for gripping around a bar or similar. Said attaching means may also be in the form of a sticky surface or hook and loop fasteners. In still another example embodiment said container 110, 110a, 110b may be provided with holes in the bottom portion 111 for screwing said bottom portion onto a suitable place. The lid 112 may be provided with perforations on any one of the vertical surfaces with respect to said perforated top surface 130.

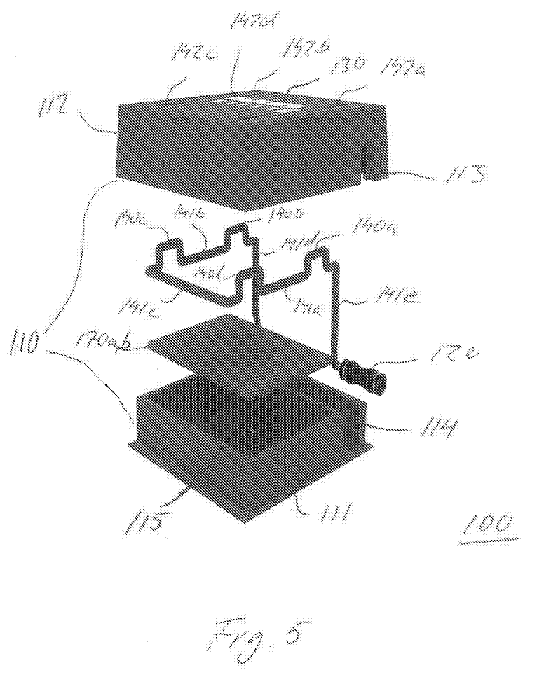

FIG. 5 depicts a perspective exploded view of another example embodiment of a fire extinguisher according to the present invention. The difference compared to FIG. 3 is that the contact ports 120 are directly contacted to the internal heat sensitive means 141a, 141b, 141a, 141d, 141e. The contacting port 120 may be in the form of a bayonet coupling for easy installation of the contacting port 120 to the internal heat sensitive means 141a, 141b, 141a, 141d, 141e as well as the as the first and second heat sensitive means 150, 152, 154. The first and second heat sensitive means 150, 152, 154 may be provided with sleeved at the end portions. Said sleeved may be in the form of metal collet which may be clamped on the first and second heat sensitive means 150, 152, 154 with a suitable clamping tool. The clamping tool may form suitable marking in the sleeve in order to securely fasten said sleeve into the contacting port 120. The sleeve may be installed and deinstalled as many times as desired. This may be advantageous if one wants to renew the first end second heat sensitive means for age, damage or other reasons such as increasing or decreasing the length of said heat sensitive means 150, 152, 154.

Groove 114 may be adapted for easy installation of said contacting ports 120 in said bottom portion 111.

The fuse or firetrain in the form of the heat sensitive means 150, 152, 154 may transfer the firetrain to the internal heat sensitive means 141a, 141b, 141a, 141d, 141e and said solid substance 170a, b. The internal heat sensitive means 141a, 141b, 141a, 141d, 141e may transfer the firetrain to the heat sensitive means 150, 152, 154, i.e., e.g. from one fire extinguisher to another as depicted in FIG. 4.

In various example embodiments the internal heat sensitive means 141a, 141b, 141a, 141d, 141e may be the same as said heat sensitive means 150, 152, 154. In various example embodiments said internal heat sensitive means 141a, 141b, 141a, 141d, 141e and said heat sensitive means 150, 152, 154 may be provided in the kit for installation by the customer.

The fire extinguisher 100 may be sold as a kit comprising at least one container 110, 110a, 110b and a predetermined length of heat sensitive means 150, 152, 154. The kit may also be sold together with a set of sleeves and a clamping tool for forming suitable connections of said heat sensitive means 150, 152, 154 to said contacting port 120, 120a, 120b. Said kit may also be provided with instructions how to clamp said sleeves onto said heat sensitive means 150, 152, 154. The clamping tool may also be provided with cutting means for cutting said heat sensitive means 150, 152, 154 into suitable lengths before providing said sleeves onto it. The contacting ports may be in the form of bayonet contacting means for easy installation and removal of said heat sensitive means 150, 152, 154. The bayonet coupling may be single sided or double sided for easy installation of internal heat sensitive means 141a, 141b, 141a, 141d, 141e and/or heat sensitive means 150, 152, 154.

We claim:

1-17. (canceled)

18. A fire extinguisher comprising: a container, a fire extinguishing substance located in said container, a force producing means located in said container, wherein said container comprises at least a first and a second contact port for removably attaching a first and/or a second heat sensitive means (or actuating said force producing means in the presence of heat above an undesired level to allow said fire extinguishing substance to pass out of said container, wherein said heat sensitive means is a heat sensitive wire and wherein said heat sensitive wire is a metallic wire having a high thermal conductivity, a fast burning substance located around said wire, cover means wrapped around said fast burning substance to provide strength for said heat sensitive means and to hold said fast burning substance in place.

19. The fire extinguisher according to claim 18, wherein said fire extinguishing substance and said force producing means is a single unit.

20. The fire extinguisher according to claim 19, wherein said single unit is in solid form.

21. The fire extinguisher according to claim 18, wherein at least a portion of said container is perforated to allow said fire extinguishing substance to pass out of said container.

22. The fire extinguisher according to claim 18, wherein said container comprises fastening means for attaching said container to an item.

23. The fire extinguisher according to claim 22, wherein said fastening means is at least one magnet.

24. The fire extinguisher according to claim 23, wherein said magnet is provided on said container opposite to said at least a portion of said container with said perforations.

25. A fire extinguisher unit comprising: a first container, a second container, a fire extinguishing substance located in said first container and in said second container, a force producing means located in said first container and in said second container, wherein said first container comprises at least a first and a second contact port for removably attaching a first and/or a second heat sensitive means for actuating said force producing means in the presence of heat above an undesired level to allow said fire extinguishing substance to pass out of said first container, said second container comprises at least a first and a second contact port for removably attaching a first and/or a second heat sensitive means for actuating said force producing means in the presence of heat above an undesired level to allow said fire extinguishing substance to pass out of said second container wherein said first and second container are configured to connected to each other via at least one heat sensitive means, wherein said heat sensitive means is a heat sensitive wire and wherein said heat sensitive wire is a metallic wire having a high thermal conductivity, a fast burning substance located around said wire, cover means wrapped around said fast burning substance to provide strength for said heat sensitive means and to hold said fast burning substance in place.

26. The fire extinguisher unit according to claim 25, wherein said fire extinguishing substance and said force producing means in at least said first container is a single unit.

27. The fire extinguisher unit according to claim 26, wherein said single unit is in solid form.

28. The fire extinguisher unit according to claim 25, wherein at least one wall of said first container and said second container is perforated to allow said fire extinguishing substance to pass out of said container.

29. The fire extinguisher unit according to claim 25, wherein at least said first container comprises fastening means for attaching said container to an item.

30. The fire extinguisher unit according to claim 29, wherein said fastening means is at least one magnet.

31. The fire extinguisher according to claim 30, wherein said magnet is provided on a wall of said at least first container opposite to a wall provided with said perforations.

32. A kit comprising at least one fire extinguisher and at least one heat sensitive means wherein said at least one fire extinguisher comprising: a container, a fire extinguishing substance located in said container, a force producing means located in said container, wherein said container comprises at least a first and a second contact port for removably attaching said at least one heat sensitive means for actuating said force producing means in the presence of heat above an undesired level to allow said fire extinguishing substance to pass out of said container, wherein said heat sensitive means is a heat sensitive wire and wherein said heat sensitive wire is a metallic wire having a high thermal conductivity, a fast burning substance located around said wire, cover means wrapped around said fast burning substance to provide strength for said heat sensitive means and to hold said fast burning substance in place.

33. The kit according to claim 32, wherein said fire extinguishing substance and said force producing means is a single unit in solid form.

34. The kit according to claim 32, wherein said heat sensitive means is at least 20 cm of said heat sensitive wire.
